(19) United States
(12) Patent Application Publication
(10) Pub. No.: US 2026/0358756 A1
(43) Pub. Date: Nov. 12, 2026

(54) FLAT HOLOGRAPHIC CAMERA

(71) Applicant: PXE COMPUTATIONAL IMAGING LTD, Kibbutz Beit Guvrin (IL)

(72) Inventors: Yoav Avraham BERLATZKY, Kibbutz Beit Guvrin (IL); Yanir HAINICK, Tel Aviv (IL)

(21) Appl. No.: 19/488,711

(22) PCT Filed: May 27, 2024
(86) PCT No.: PCT/IL2024/050520

§ 371 Date: Nov. 28, 2025

Related U.S. Application Data
(60) Provisional application No. 63/505,090, filed on May 31, 2023.

(51) Int. Cl. G03H 1/04; H04N 23/55; H04N 23/90

(52) U.S. Cl. CPC G03H 1/0443; H04N 23/55; H04N 23/90; G03H 2001/0445; G03H 2001/0452; G03H 2223/18; G03H 2223/19; G03H 2223/23; G03H 2223/50

(57) ABSTRACT

A camera system is describes, comprising: a detector array comprising a plurality of light sensitive pixels; an encoder mask comprising an array of a plurality of encoders, each of said plurality of encoders comprises an array of a plurality of similar unit cells; and an array of lenses comprising a plurality of optical lenses aligned with said array of plurality of encoders and positioned for imaging input light onto said plurality of encoders. Wherein the camera system is configured to divert collected light components collected from a scene onto each of said plurality of optical lenses with respective angular shift, providing that each lens collects light with a respective angular range.

### TECHNOLOGICAL FIELD

The present disclosure relates to a flat camera configuration, and specifically relates to a flat holographic camera arrangement comprising a plurality of camera units.

### BACKGROUND

Optical imaging is a powerful tool for measurements, inspection, and imaging. Current optical measurement and imaging techniques can provide high-resolution data on the intensity of an input optical field. However, a great portion of the information carried by the optical field is lost in typical conventional imaging techniques that measure only the intensity of the field.

Flat cameras are a versatile type of camera that can be used for a variety of purposes. Flat cameras are designed to fit into relatively compact cases or provide compact form factor. Such flat cameras are often used in portable electronic devices. They are ideal for taking snapshots, travel photography, and event photography. Flat cameras are also a good choice for vlogging and filmmaking.

Various techniques utilizing holographic cameras include:

U.S. Pat. No. 11,293,806, assigned to the assignee of the present application, describes an optical detection system for detecting data on the optical mutual coherence function of input field. The system comprising an encoder having similar unit cells, and an array of sensor cells located at a distance downstream of said unit cells with respect to a general direction of propagation of input light. The array defines a plurality of sub-array unit cells, each sub-array corresponding to a unit cell of the encoder, and each sub-array comprising a predetermined number M of sensor elements. The encoder applies predetermined modulation to input light collected by the system, such that each unit cell of said encoder directs a portion of the collected input light incident thereon onto sub-array unit cell corresponding therewith and one or more neighboring sub-array unit cells within a predetermined proximity region. The number M is determined in accordance with a predetermined number of sub-arrays unit cells within the proximity region.

US 2023/029,930, assigned to the assignee of the present application, provides systems and methods for imaging, measuring an object, and characterizing a sample. An optical, speckle-based imaging system may comprise an illumination unit comprising at least one coherent light source to illuminate a sample; a collection unit for collecting input light from the sample, the collection unit consisting of an imaging optics and a wavefront imaging sensor; and a control unit coupled to the illumination unit and the collection unit for analyzing the input light and generating a speckle wavefront image, wherein the at least one coherent light source is to generate primary speckles in the sample or thereon, and the imaging optics is to capture a secondary speckle pattern induced by the illumination unit in the sample or thereon.

WO 2021/229,575, assigned to the assignee of the present application, provides systems and methods for digital optical aberration correction and spectral imaging. An optical system may comprise an optical imaging unit, to form an optical image near an image plane of the optical system; a wavefront imaging sensor unit located near the image plane, to provide raw digital data on an optical field and image output near the image plane; and a control unit for processing the raw digital data and the image output to provide deblurred image output, wherein the control unit comprises a storage unit that stores instructions and a processing unit to execute the instructions to receive the image input and the raw digital data of the optical field impinging on the wavefront imaging sensor and generate a deblurred image based on an analysis of the optical mutual coherence function at the imaging plane.

### GENERAL DESCRIPTION

There is a need for a camera configuration enabling holographic imaging to obtain data on coherence of input light, while maintaining a flat configuration suitable for use if typical electronic devices. The present disclosure provides a camera system formed of a plurality of holographic camera units configured to provide output data indicative of intensity and phase or coherence pattern of collected light. The camera system is configured so that the plurality of camera units collects a plurality of image portions covering together a total field of view of the camera system.

The camera system may be configured with a layered structure having a detector array, encoder mask, and array of imaging lenses. The encoder mask is formed of a plurality of encoders, each carrying a periodic pattern of a plurality of unit cells having light modulating pattern. The light modulating pattern is similar between unit cells of the encoder. This is while the different encoders of the encoder mask may be similar or different between them.

The camera system is generally configured such that each of the camera units collects light from a respective angular portion of a total field of view of the camera systems. Where angular portions of the different camera units may be partially overlapping or separate between them. To this end the camera system may comprise a light diverting element, configured to direct light components of different angular portions of the field of view toward the different camera units of the system. The light diverting optical element may be refractive, diffractive, or utilize a metasurface. Alternatively, or additionally, the different camera units may be configured with suitable effective optical axes directed at different angular orientations with respect to a general optical axis of the camera system. For example, in some embodiments, the array of lenses may be configured such that each lens of the array has slightly different optical axis. in such example, lenses at the center of the array may have optical axis parallel to general optical axis of the system, where for each row or column optical axis of the lens shifts toward periphery of the field of view. In some other examples, a light diverting optical element may be a metasurface, a refractive or a diffractive optical element configured to operate to vary angular range of light collection as well as provide imaging conditions for each of the camera units.

The camera system of the present disclosure may be used in various electronic devices and configured to provide image data indicative of at least one of phase, coherence, depth data in addition to provide imaging (i.e., conventional imaging) of the field of view. Such output data may be used to determine wavelength components of collected light to determine chromatic and/or hyperchromatic image data in accordance with phase variations of the collected light components.

Further, the use of holographic camera units enables reconstruction of the collected image data for correction of optical aberrations. This may include correction of optical aberration generated due to light diverting by the light diverting optical element. The phase and/or coherence data may also be used to determine depth information of the collected image data and utilize output image data for performing various post processing such as facial recognition, detection of biometric parameters, differentiating between physical objects and two-dimensional representation thereof, etc.

Thus, according to a broad aspect, the present disclosure provides a camera system comprising: a detector array comprising a plurality of light sensitive pixels, an encoder mask comprising an array of a plurality of encoders, each of said plurality of encoders comprises an array of a plurality of similar unit cells, an array of lenses comprising a plurality of optical lenses aligned with said array of plurality of encoders and positioned for imaging input light onto said plurality of encoders; wherein said camera system is configured to divert collected light components collected from a scene onto each of said plurality of optical lenses with respective angular shift, providing that each lens collects light with a respective angular range. For example, each of the lenses may collect light arriving from a respective angular range within the scene. In some embodiments, different lenses collect light from different angular ranged, which may be partially overlapping, of the scene.

According to some embodiments, the camera system is configured to define an array of camera units, wherein each camera unit is defined by an imaging lens, a respective encoder, and a sub-arrangement of light sensitive pixels.

According to some embodiments, the plurality of light sensitive pixels comprises an arrangement of sub-array unit cells, each sub-array unit cell being associated with a unit cell of the respective encoder and comprises a selected number of pixels.

According to some embodiments, the selected number of pixels of said sub-array unit cell is selected in accordance with a number of sub-array unit cells within the predetermined proximity region.

According to some embodiments, the plurality of similar unit cells of said plurality of encoders carry a light modulating pattern selected to expand a portion of light impinging thereon onto a predetermined proximity region, said proximity region comprises a respective sub-array unit cell of the detector array, and by one or more sub-array unit cells associated with one or more neighboring unit cells of the encoder.

According to some embodiments, the plurality of encoders is configured with similar light modulation pattern in the respective plurality of unit cells.

According to some embodiments, a light modulation pattern of said plurality of unit cells varied between said plurality of encoders.

According to some embodiments, the camera system may further comprise one or more field stop apertures, located between said array of lenses and said holographic encoder mask, said one or more field stop aperture being positioned to prevent light collected by one imaging lens from impinging onto encoder associated with another imaging lens.

According to some embodiments, the plurality of optical lenses of said array of lenses comprises imaging lenses having tilted optical axis, providing that each lens of the array of lenses collects light from a different a respective angular range.

According to some embodiments, the camera system may comprise a light diverting optical element positioned upstream of said array of lenses and configured to direct collected light components collected from a scene onto each of said plurality of optical lenses with respective angular shift, providing that each lens collects light with a respective angular range.

According to some embodiments, the light diverting optical element comprises a refractive aspheric lens unit adapted for diverting light components providing that each lens of the array of lenses collects light from a different a respective angular range.

According to some embodiments, the light diverting optical element comprises a diffractive optical adapted for diverting light components providing that each lens of the array of lenses collects light from a different a respective angular range.

According to some embodiments, the light diverting optical element comprises a Fresnel lens adapted for diverting light components providing that each lens of the array of lenses collects light from a different a respective angular range.

According to some embodiments, the light diverting optical element comprises one or more prisms adapted for diverting light components providing that each lens of the array of lenses collects light from a different a respective angular range.

According to some embodiments, the light diverting optical element comprises a meta-surface unit carrying a plurality of nanostructures arranged in a selected pattern to provide selected light diverting pattern for diverting light components providing that each lens of the array of lenses collects light from a different a respective angular range.

According to some embodiments, the array of lenses is formed of a metasurface element having microscopic surface pattern selected to affect propagation of light components passing therethrough to provide imaging conditions, and for directing light components collected from respective angular portions of the field of view along optical axis of the camera system toward the different encoders of the encoder mask.

According to some embodiments, the camera system may further comprise a control unit, said control unit being adapted for receiving detection data from said detector array, and for processing said detection data to determine a plurality of coherence image data pieces each associated with light portion collected by different lenses of said array of lenses.

According to some embodiments, the plurality of coherence image data pieces comprises collected image data and coherence matrix data of collected light.

According to some embodiments, the control unit is further adapted for processing said plurality of coherence image data pieces to determine a coherence image indictive of field of view of the camera system.

According to some embodiments, the processing said plurality of coherence image data pieces to determine a coherence image indictive of field of view of the camera system comprises determining coherence matrix in overlapping image regions associated with overlap in angular range of light collection of said array of lenses.

According to one other broad aspect, the present disclosure provides a camera system comprising an array of camera units;
(a) wherein said array of camera units comprises two or more holographic camera units, each comprising an encoder formed by an array of a plurality of similar unit cells, and respective detector array; and
(b) wherein said two or more holographic camera units being adapted for collecting light from a portion of a total field of view of said camera system, such that the plurality of said two or more holographic camera units cover said total field of view of said camera system.

According to some embodiments, the two or more holographic camera units are each associated with an imaging lens collecting light components associated with a respective angular range of field of view of said camera system.

According to some embodiments, the camera system further comprising a light diverting optical element adapted to shift light components providing that each of said two or more holographic camera units collects light with a respective angular range.

According to some embodiments, the light diverting optical element comprises at least one of: a-spheric lens unit, diffractive grating, Fresnel lens, meta-surface optical element.

Generally, the camera system may be configured in accordance with the below description where combination of features illustrated as part of various embodiments described herein may be sued.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 schematically illustrates a camera system according to some embodiments of the present disclosure;

FIG. 2 exemplifies a camera system according to some embodiments of the present disclosure having layered arrangement;

FIG. 3 illustrated a holographic camera unit according to some embodiments of the present disclosure;

FIG. 4 exemplifies a plurality of image portions collected by a camera system according to some embodiments of the present disclosure;

FIG. 5 illustrates a camera system utilizing an aspheric lens according to some embodiments of the present disclosure;

FIG. 6 illustrates a camera system utilizing a Fresnel lens according to some embodiments of the present disclosure;

FIG. 7 exemplifies a metasurface suitable for use in a camera system according to some embodiments of the present disclosure;

FIG. 8 exemplifies a camera system utilizing an aspheric lens according to some embodiments of the present disclosure;

FIG. 9 exemplifies light components path in a camera system according to some embodiments of the present disclosure;

FIG. 10A illustrates an imaging lens according to some embodiments of the present disclosure, and FIGS. 10B to 10C illustrate light modulating pattern of unit cells of an encoder according to some embodiments of the present disclosure; and

FIG. 11 illustrates a camera system according to some embodiments of the invention, specifically exemplifying operation of a light diverting optical element and an aspheric lens.

### DETAILED DESCRIPTION OF EMBODIMENTS

As indicated above, the present disclosure provides a flat camera system formed of a plurality of camera units, preferably holographic camera units, arranged in a selected array and configured to collect input light such that each of the plurality of camera units collects light associated with a portion of a total field of view of the camera system.

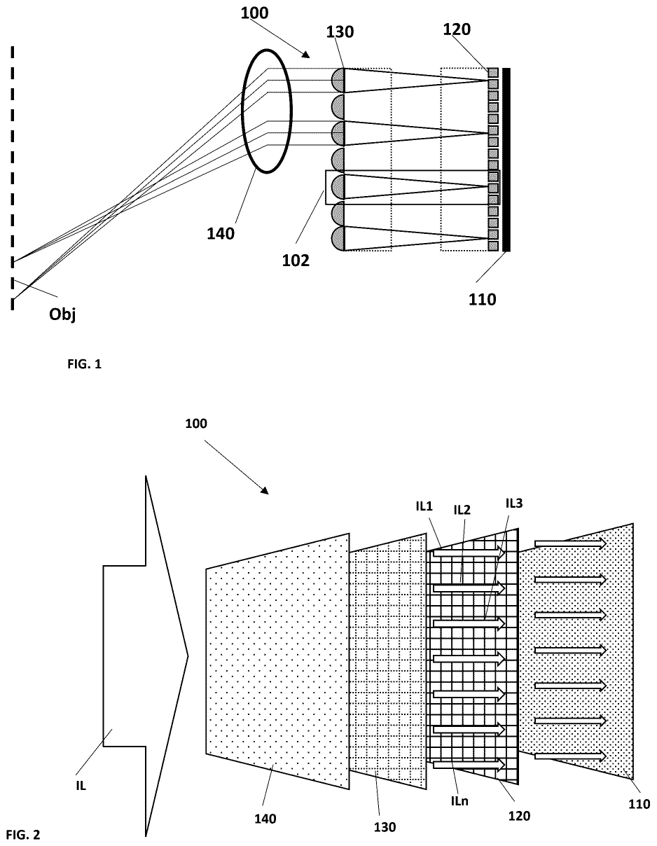

Reference is made to FIG. 1 schematically illustrating a camera system 100 according to some embodiments of the present disclosure. the camera system 100 is formed of a plurality of camera units arranged in an array and is configured to provide light collection from a scene such that each of the plurality of camera units collects light from a portion of the total field of view (FOV), typically with certain overlap in FOV portions of the different camera units generally marked 102.

As illustrated in FIG. 1, system 100 includes a detector array 110, holographic encoder mask 120 and an array of imaging lenses 130. The detector array 110 includes a plurality of light sensitive pixels, generally arranged in an array, and configured to generate output electrical signals indicative of aggregated light intensity of a selected wavelength range impinging thereon. The holographic encoder mask 120 includes an array of holographic encoders, where each of the holographic encoders if formed of an array of unit cells having selected light modulating pattern being similar between the unit cells of the same encoder. The array of lenses 130 includes a plurality of imaging lenses, each aligned with a respective holographic encoder of the encoder mask 120, and a respective region of the detector array 110. This configuration defines a plurality of camera units 102, each formed by an arrangement of an imaging lens, holographic mask, and array of light sensitive pixels.

Further, according to the present disclosure, the camera system is configured to provide light collection pattern, such that each of the plurality of camera units 102 collects light arriving from a portion of a total field of view. This is exemplified by optical element 140 configured to bend light portions impinging on different regions thereof, such that light input to each one of the camera units 102 corresponds with different, generally partially overlapping, angular region of the field of view. light diverting optical element 140 may be implemented by selected shaping of the lenses of array of lenses 130, or be a separate optical element utilizing refraction, diffraction and/or surface manipulation as described in more details below.

Accordingly, as exemplified in FIG. 1, the camera system 100 is formed of a plurality of camera units 102, and a light diverting optical element 140 providing that the different camera units 102 collect light from different angular section of the field of view. Accordingly, an object Obj located at a certain position in the field of view will generate image in a number of camera units, in accordance with their location within the array, while other camera units of the array may collect light from other angular sections of the field of view.

FIG. 2 illustrates an additional exemplary configuration of a flat camera system 100 according to some embodiments of the present disclosure. As shown, the camera system 100 may be formed in a layer-by-layer configuration, including a detector array layer 110, encoder mask 120, lens array 130 and light diverting optical element 140 (which may or may not be a part of the lens array 130). The camera system 100 may generally also include one or more array of apertures, acting as field stops for the different camera units (102 in FIG. 1), and positioned to direct light collected by an imaging lens of the lens array 130 through the respective holographic encoder to the respective region of the detector 140, while preventing cross-talk between the camera units.

It should be noted, although not specifically illustrated in FIG. 1 or 2, that the camera system 100 may generally be associated with a control unit. The control unit may include one or more processors and memory circuitry (PMC) and respective input/output modules. The PMC is generally operatively connected to at least the detector array 110 for determining light collection and readout, for receiving output data from the detector array 110 and for processing the output data as described in more detail further below.

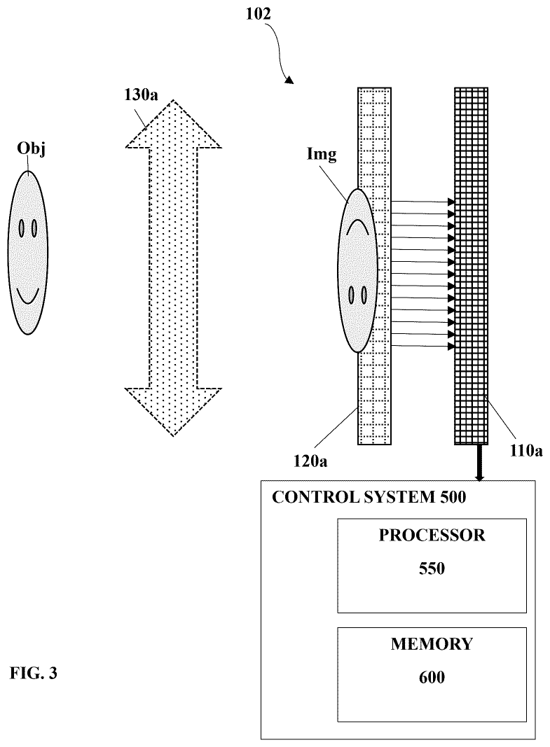

The camera system 100 of the present disclosure utilizes an encoder mask 120, located at image plane with respect to the imaging lenses of the array of lenses 130. In this connection, reference is made to FIG. 3 exemplifying configuration and general operation of a camera unit 102 according to some embodiments of the present disclosure. Camera unit 102 includes an imaging lens 130a, a holographic encoder 120a and a detector array 110a, and is operable for detection of light field phase, coherence, and intensity data.

The holographic encoder 120a carries an array of a plurality of similarly patterned unit cells, each having a light modulating pattern configured to expand at least a portion of light passing therethrough. The detector array 110a is placed at a predetermined distance L downstream of the encoder 120a with respect to general direction of radiation propagation. The imaging lens 130a is positioned to form an image Img of an object Obj on surface of the encoder 120a, where the encoder modulates the collected light propagating to the detector array 110a.

The detector array 110a includes a plurality of light sensitive detectors (pixels) generally forming a plurality of sub-array unit cells, where each sub-array unit cell is associated with a respective unit cell of the encoder 120a. Further, the light modulating pattern of each of the unit cells of the encoder 120a modulated light components passing therethrough, and expands at least a portion of the light components to impinge on the detector array within a predetermined proximity region, generally including one or more neighboring sub-array unit cells in addition to the sub-array unit cell associated with the unit cell of the encoder. Such light modulation causes crosstalk between light components associated with different unit cells of the encoder, enabling processing of output data collected by the detector for determining data on light intensity, as well as coherence matrix and/or phase data of the collected light.

Each camera unit 102, and/or the entire camera system 100 may be connected to, or associated with, a control unit 500. As indicated above, the control unit may include at least one processor 550 and memory 600, and relevant input/output modules. The at least one processor 550 is configured and operable for receiving output data from the detector 110a and for processing the output data in accordance with pre-stored data on modulation pattern of the encoder 120a. Generally, the processor may operate for determining a set of coefficients, associated with different coherence basis functions, and their respective intensity basis function as would be collected by the detector. The processor may determine a linear sum of the intensity basis functions that fits the output data collected by the detector and utilizes the respective coefficients for determining coherence data on the collected wavefront, being a sum of coherence basis functions.

The configuration of the holographic encoder and processing enabling to determine at least a coherence matrix of collected light is described in U.S. Pat. No. 11,293,806 assigned to the assignee of the present disclosure and incorporated herein with reference.

It should be noted that in some embodiments of the invention, the encoder 120 may be a separate unit from the detector array 140, while in other embodiments, the encoder 120 may be monolithically integrated with the detector array 140, and even be part of the process stack used to manufacture the sensor array, e.g. using metallization process steps, and/or process steps similar to those used in manufacturing micro-lens arrays typically used to improve pixel fill-factors in sensor arrays. Additionally, as indicated above, the light diverting optical element 140 may be manifested by suitable design of the lenses of the lens array 130, providing that each lens collects light from a respective angular section of the field of view of the system 100. Alternatively, a separate light diverting optical element may be used as described in more details below.

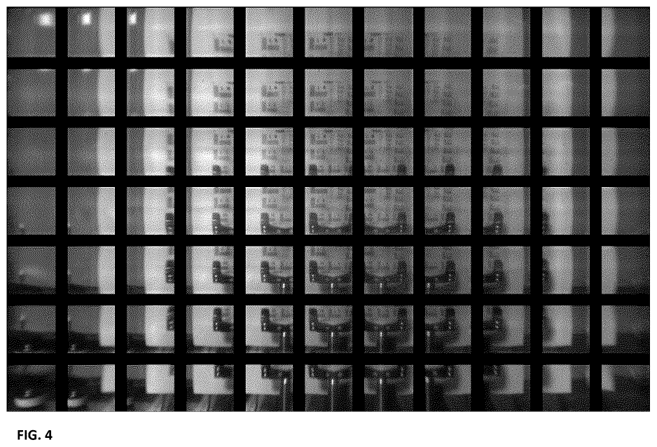

An exemplary image collected by the camera system 100 of the present disclosure is shown in FIG. 4. FIG. 4 shows an array of 7×11 image portions, each collected by a camera unit 102 of a flat camera system 100 configured as described hereinabove. The image portions illustrated herein are shown as simple image portions, and coherence and/or phase data is not specifically shown. However, the array of image portions does illustrate variation of field of view between the camera units 102 of the camera system, where each camera unit collects light from an angular portion of the total field of view. As shown, the angular portions of adjacent camera units may be partially overlapping. More specifically, in some embodiments the angular portions of the field of view of the different camera units 102 may be partially overlapping. In some other embodiments, angular portions of field of view of some of the camera units may be partially overlapping, while some other camera units have separate fields of view. Such separated fields of view may be interfacing or spaced apart. In some embodiments, fields of view of the different camera units may be non-overlapping.

Generally, the use of wavefront camera units 102 as described herein, provides additional data on phase and coherence of the collected light over the intensity images illustrated in FIG. 4. The additional phase and/or coherence data can be used to reconstruct the array of image portions into a complete image of the field of view and utilize phase and/or coherence variations for identifying depth relations, generating three-dimensional amp of the scene, identifying selected materials and additional details. This enables performing various analysis operations includes face recognition, differentiating between physical objects and two-dimensional images thereof etc.

Generally, collection of light components of different angular portions of the field of view may cause various optical aberrations due to the variation of optical axis. The camera system of the present disclosure utilizes holographic camera units configured to provide coherence and/or phase data enabling correction of various aberrations using post processing operations.

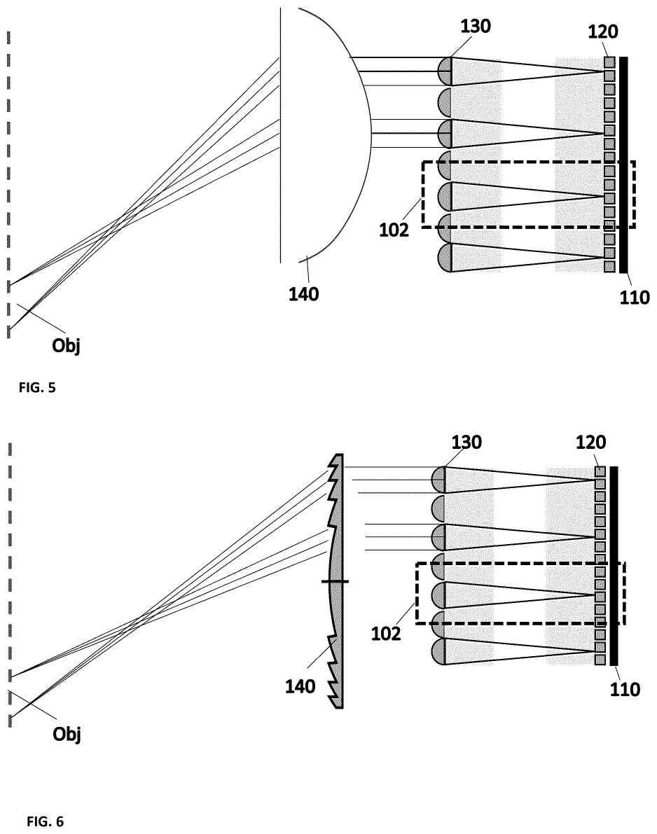

Reference is further made to FIGS. 5 and 6 illustrating two examples of camera systems 100 according to some embodiments of the present disclosure utilizing aspheric lens (FIG. 5) or Fresnel lens (FIG. 6) operating as light diverting optical elements 140. The camera system 100 exemplified is generally similar to that exemplified in FIG. 1, using an array of imaging lenses 130, encoder mask formed by an array of holographic encoders 120 and a detector array 110. The aspheric lens unit 140 illustrated in FIG. 5 is shaped to provide light diverting that directs light components to each camera unit within an angular range determined based on location of the camera unit 102 within the array.

The example of FIG. 6 utilizes a Fresnel lens as light diverting optical element 140. A Fresnel lens is a composite compact lens that utilizes combination between diffraction and refraction to properly shape light passing therethrough. According to the present disclosure, the camera system 100 may utilize a Fresnel lens shape to direct light in accordance with transverse location on the lens. More specifically, the Fresnel lens is configured to provide light components of different angular range to align with optical axis of the camera system, where the angular range is determined in accordance with transverse location on the surface of the lens, to thereby transmit the respective angular portions to the different camera units 102.

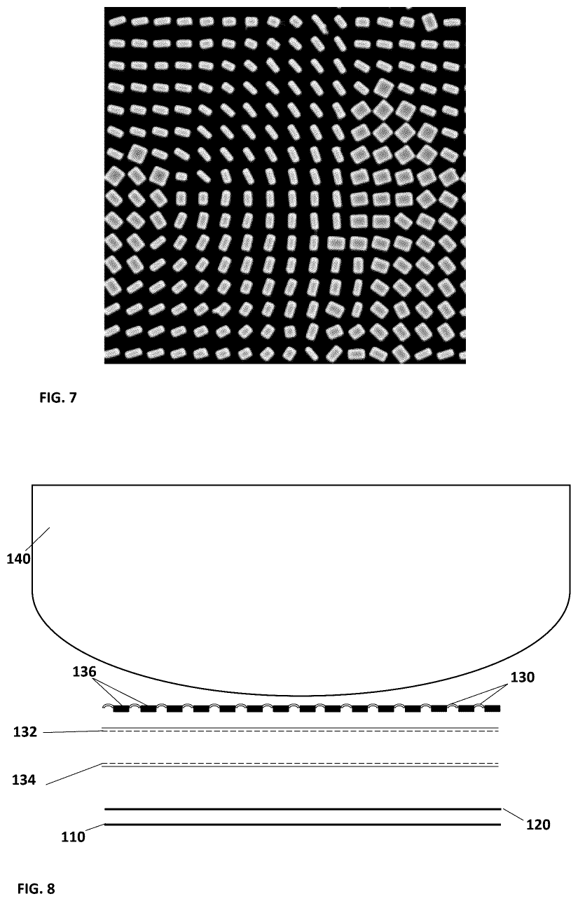

In some additional embodiments, the light diverting optical element 140 mat be a diffractive grating, having selected grating variation to provide the desired light diverting. Additionally, or alternatively, the light diverting optical element may be formed by one or more meta-surfaces having selected microscopic patterns selected to apply diffraction and/or refraction properties to light passing through the element 140. An example of metasurface configuration is illustrated in FIG. 7. FIG. 7 is a scanning electron microscope image of meta surface described by Lisa W. Li et al in “Evaluation and characterization of imaging polarimetry through metasurface polarization gratings”, applied optics Vol. 62, No. 7/1 Mar. 2023. Generally, metasurfaces are physical elements, including optical elements having surface pattern formed of a plurality of micro and/or nano structures arranged in selected arrangement and having selected size and shapes to affect light components interacting with the metasurface.

A non-limiting example of the camera system according to some embodiments of the present disclosure is illustrated in FIG. 8. FIG. 8 shows an illustration of the camera system utilizing an aspheric lens acting as light diverting optical element 140, however it should be understood that the light diverting optical element may be a diffractive element, Fresnel lens, metasurface element or other suitable elements as described above.

FIG. 8 illustrates a camera system 100 according to some embodiments of the present disclosure. As indicated above, the system includes a light diverting optical element 140, array of imaging lenses 120, an encoder mask 120, and detector array that is not specifically shown in FIG. 8. Additional elements illustrated in FIG. 8 are light blocking regions 136 positioned between the imaging lenses of the array 130, and a plurality of field stop aperture arrays 132 and 134 located between the array of lenses 130 and the encoder mask 120. The apertures 132 and 134 and the light blocking regions 136 are positioned and configured to block light components from propagating between the camera units 102 of the system, and thus to prevent crosstalk between the camera units 102. This is contrary to the crosstalk between unit cells of the holographic encoder 120a used in each one of the camera units 102, where such crosstalk is leveraged to obtain phase and/or coherence data of collected light.

Generally, in some embodiments, a distance between the encoder mask 120 defining the image plane and the array of lenses 130 may be between 0.1 and 5 millimeters. for example, the distance may be 2.9 millimeters. Generally, the distance between the lenses 130 and encoder mask 120 is determined in accordance with optical power of the imaging lenses 130 and desired imaging conditions of the camera system 100. In some embodiments, one or more optical elements may be shiftable to vary a focusing distance in according to different imaging conditions. It should however be noted that the use of holographic camera units, capable of determining phase and/or coherence matrix of collected light in addition to intensity mapping thereof, may enable processing of the collected image to correct defocusing or other optical aberrations that occur in various imaging conditions. Further, as shown, the use of aspheric lens 140 may result in relatively thick camera system, due to the relative high thickness of the aspheric lens. Accordingly, the use of diffractive grating, Fresnel lens, and/or metasurface, may be preferred, allowing lower thickness to the camera system.

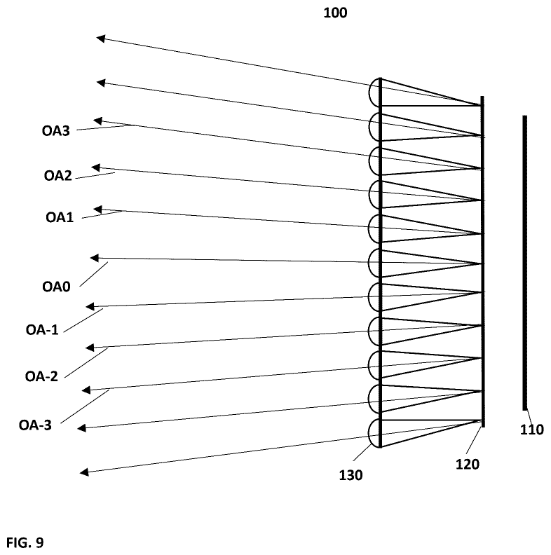

Reference is made to FIG. 9 illustrating an additional exemplary configuration of the camera system 100 according to some embodiments of the present disclosure. As shown, in this configuration, spatial arrangement of the imaging lenses of the lens array 130, provide variation of optical axis between the camera units. More specifically, a central camera unit of the array has optical axis OA0, aligned with general optical axis of the camera system 100. Each of the other camera units, has optical axis that is tilted from the general optical axis by a measure determined based on distance and direction of each camera unit from the center of the array. As shown optical axis OA1 is tilted slightly upward, OA2 is tilted a bit mor upward, and optical axis OA3 is further tilted upward. Similar tilt is provided to optical axes OA-1, OA-2, and OA-3. This provides an effective configuration of the optical axes that resembles the spears in a roman phalanx configuration, or a porcupine.

Such configuration may be achieved by determining increasing dimensions of the elements extending from the detector array 110 toward the lens array 130, such that the encoder mask 120 is larger than the detector array 110, and the array of lenses 130 takes furthermore transverse area. alternatively, or additionally, the imaging lenses of the array 130 may be shaped to provide optical axis variations in a similar phalanx or porcupine configuration.

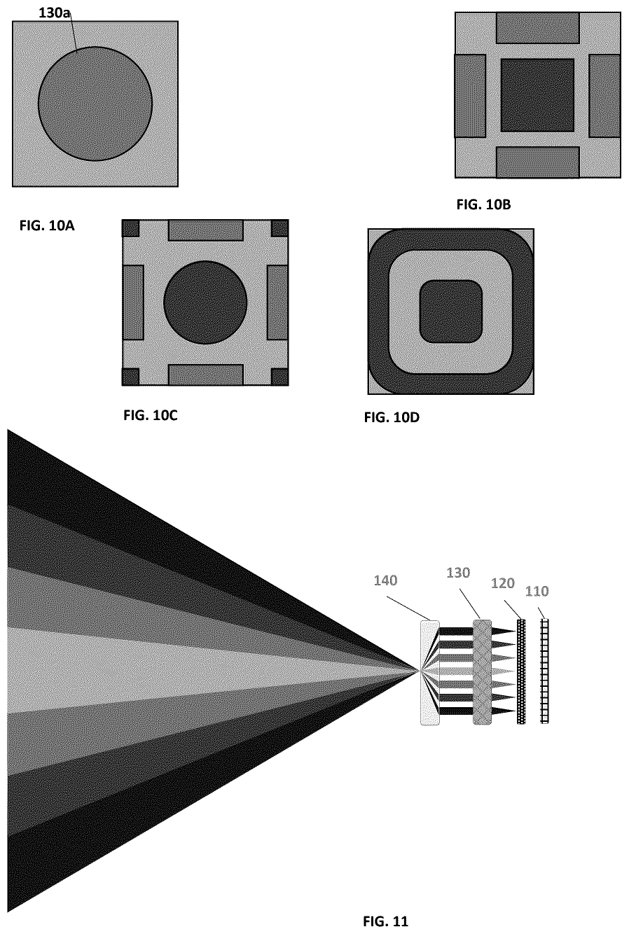

As indicated above, the camera system 100 of the present disclosure is formed using array of lenses 130 and an array of holographic encoders 120. Further, the encoder mask is formed of an array of holographic encoders, each being an array of similar unit cells carrying light modulating pattern. Exemplary configurations of an imaging lens 130a, and unit cells of the holographic encoder are illustrated in FIGS. 10A to 10D.

FIG. 10A exemplifies an imaging lens 130a. The imaging lens may have diameter between 0.1 and 1 millimeter, or any other diameter to provide the proper dimensions of the camera system. Further imaging lens 130a may have focal length selected based on dimensions of the camera system, distance between the lens array 130 and the encoder mask 120, desired focusing distance and general optical requirements. for example, the focal length of the imaging lenses 130 a may be between 0.1 to 10 millimeters. The imaging lens 130a may take the entire space of unit cell of the lens array 130 or a portion thereof, in accordance with proper optical design of the camera system.

FIGS. 10B to 10D show three examples of light modulating pattern of a unit cell in a holographic encoder according to some embodiments of the present disclosure. A typical dimension of the unit cell is between 1 and 10 micrometers, and the light modulating pattern may be formed by regions differing in optical path of light passing therethrough, i.e., phase affecting regions. Each holographic encoder 120a includes a plurality of similar unit cells arranged in an array. The encoder mask includes an array of holographic encoders, each aligned to phase a respective imaging lens of the lens array. The different holographic encoders may have similar or different holographic masks, having preselected and known light modulation patterns thereon.

FIG. 11 illustrates a camera system according to some embodiments of the invention, and specifically illustrates operation of the light diverting optical element 140, and specifically exemplifying an aspheric lens. As shown, the light diverting optical element is configured to direct light components into the different camera units 102, defined by the different imaging lenses of the array of lenses 130, in accordance with angular field of view portions. Accordingly, light components that propagate parallel to optical axis of the camera system, are collected, and transmitted to the imaging lens at a central location of the array. This is while, light components propagating at an angle to the optical axis of the system, are collected at periphery of the light diverting optical element and aligned to optical axis of peripheral imaging lenses of the array of lenses 130. This configuration provides that each camera unit collected light associated with a portion of the field of view of the camera system. It should be noted that FIG. 11 exemplifies one configuration of light diverting element providing inverting of the collected light within a transverse plane. Alternatively, FIG. 9 exemplifies another configuration when the collected light maintains transverse orientation when being collected by the light diverging optical element. It should be noted that this is a function of the specific light diverting optical element used and may be corrected by orientation of the collected image data.

As indicated above, the camera system of the present disclosure may be manufactured in a layer-by-layer configuration. More specifically, a first, detector array layer, may be placed on a support followed by an encoder mask layer. one or more arrays of field stop apertures may be placed on top of the encoder mask, to prevent light leakage between the camera units of the system, followed by a lens array and a light diverting optical element. The different elements are preferably aligned to provide suitable optical axes for each of the camera units of the system.

Thus, the present disclosure provides a camera system formed of a plurality of camera units, where the plurality of camera units comprises one or more holographic camera units configured for determining intensity and phase and/or coherence data on collected light. The camera system is configured such that plurality of camera units collect light from respective plurality of angular sections of the field of view. The camera units thus collected light from a plurality of field of views, which may be partially overlapping.

It is to be noted that the various features described in the various embodiments can be combined according to all possible technical combinations.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based can readily be utilized as a basis for designing other structures, methods, and systems for carrying out the several purposes of the presently disclosed subject matter.

Those skilled in the art will readily appreciate that various modifications and changes can be applied to the embodiments of the invention as hereinbefore described without departing from its scope, defined in and by the appended claims.

1. A camera system comprising:
(a) a detector array comprising a plurality of light sensitive pixels;
(b) an encoder mask comprising an array of a plurality of encoders, each of said plurality of encoders comprises an array of a plurality of similar unit cells;
(c) an array of lenses comprising a plurality of optical lenses aligned with said array of plurality of encoders and positioned for imaging input light onto said plurality of encoders; and
further comprising a light diverting optical element positioned upstream of the array of lenses and configured to direct collected light components collected from a scene onto each of said plurality of optical lenses with respective angular shift, providing that each lens collects light with a respective angular range.

2. The camera system of claim 1, defining an array of camera units, wherein each camera unit comprises an imaging lens, a respective encoder, and a sub-arrangement of light sensitive pixels.

3. The camera system of claim 1, wherein said plurality of light sensitive pixels comprise an arrangement of sub-array unit cells, each sub-array unit cell being associated with a unit cell of the respective encoder and comprises a selected number of pixels.

4. The camera system of claim 3, wherein said selected number of pixels of said sub-array unit cell is selected to match a number of sub-array unit cells within the predetermined proximity region.

5. The camera system of claim 1, wherein said plurality of similar unit cells of said plurality of encoders carry a light modulating pattern selected to expand a portion of light impinging thereon onto a predetermined proximity region, said proximity region comprises a respective sub-array unit cell of the detector array, and by one or more sub-array unit cells associated with one or more neighboring units cells of the encoder.

6. The camera system of claim 1, wherein said plurality of encoders are configured with similar light modulation pattern in the respective plurality of unit cells.

7. The camera system of claim 1, wherein light modulation pattern of said plurality of unit cells varied between said plurality of encoders.

8. The camera system of claim 1, further comprising one or more field stop apertures, located between said array of lenses and said encoder mask, said one or more field stop aperture being positioned to prevent light collected by one imaging lens from impinging onto encoder associated with another imaging lens.

9. The camera system of claim 1, wherein said plurality of optical lenses of said array of lenses comprises imaging lenses having tilted optical axis, providing that each lens of the array of lenses collects light from a different a respective angular range.

10. (canceled)

11. The camera system of claim 10 1, wherein said light diverting optical element comprises a refractive aspheric lens unit adapted for diverting light components providing that each lens of the array of lenses collects light from a different a respective angular range.

12. The camera system of claim 1, wherein said light diverting optical element comprises a diffractive optical adapted for diverting light components providing that each lens of the array of lenses collects light from a different a respective angular range.

13. The camera system of claim 1, wherein said light diverting optical element comprises a Fresnel lens adapted for diverting light components providing that each lens of the array of lenses collects light from a different a respective angular range.

14. The camera system of claim 1, wherein said light diverting optical element comprises one or more prisms adapted for diverting light components providing that each lens of the array of lenses collects light from a different a respective angular range.

15. The camera system of claim 1, wherein said light diverting optical element comprises a meta-surface unit carrying a plurality of nanostructures arranged in a selected pattern to provide selected light diverting pattern for diverting light components providing that each lens of the array of lenses collects light from a different a respective angular range.

16. (canceled)

17. The camera system of claim 1, further comprising a control unit, said control unit being adapted for receiving detection data from said detector array, and for processing said detection data to determine a plurality of coherence image data pieces each associated with light portion collected by different lenses of said array of lenses, said coherence image data pieces comprise collected image data and coherence matrix data of collected light.

18. (canceled)

19. (canceled)

20. The system of claim 17, wherein said processing said plurality of coherence image data pieces to determine a coherence image of field of view of the camera system comprises determining coherence matrix in overlapping image regions associated with overlap in angular range of light collection of said array of lenses.

21. A camera system comprising an array of camera units;
(a) wherein said array of camera units comprises two or more holographic camera units, each comprising an encoder formed by an array of a plurality of similar unit cells, a respective detector array, and an imaging lens collecting light components associated with a respective angular range of field of view of said camera system; and
(b) wherein said two or more holographic camera units being adapted for collecting light from a portion of a total field of view of said camera system.

22. (canceled)

23. The camera system of claim 21, further comprising a light diverting optical element adapted to shift light components providing that each of said two or more holographic camera units collects light with a respective angular range.

24. The camera system of claim 23, wherein said light diverting optical element comprises at least one of: a-spheric lens unit, diffractive grating, Fresnel lens, meta-surface optical element.

25. A camera system comprising:
(a) a detector array comprising a plurality of light sensitive pixels;
(b) an encoder mask comprising an array of a plurality of encoders, each of said plurality of encoders comprises an array of a plurality of similar unit cells;
an array of lenses comprising a plurality of optical lenses aligned with said array of plurality of encoders and positioned for imaging input light onto said plurality of encoders; and
wherein said camera system is configured to divert collected light components collected from a scene onto each of said plurality of optical lenses with respective angular shift, providing that each lens collects light with a respective angular range; and
wherein said array of lenses is formed of a metasurface element having microscopic surface pattern selected to affect propagation of light components passing therethrough to provide imaging conditions, and for directing light components collected from respective angular portions of the field of view along optical axis of the camera system toward the different encoders of the encoder mask.
